(19) United States
(12) Patent Application Publication
(10) Pub. No.: US 2024/0397553 A1
(43) Pub. Date: Nov. 28, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/666,832

(22) Filed: May 17, 2024

(30) Foreign Application Priority Data
May 22, 2023 (CN) 202310579866.1

(51) Int. Cl. H04W 74/0833; H04W 72/231; H04W 74/00; H04W 76/20

(52) U.S. Cl. CPC H04W 74/0833; H04W 72/231; H04W 74/002; H04W 76/20

(57) ABSTRACT

The present application discloses a method and device for wireless communications, comprising transmitting a first signal, and the first signal indicating a request for a first system information block; receiving a first system information block transmitted by broadcast; wherein the first node is in RRC_CONNECTED state; whether the first signal is a signal transmitted on a PRACH or an RRC message occupying a CCCH in a random access procedure or an RRC message occupying a DCCH is dependent on a first parameter set, at least a latter of a downlink reception time and an uplink transmission time is dependent on the first parameter set. The present application can save more electricity through the first signal.

### CROSS REFERENCE TO RELATED APPLICATIONS

The present application claims the priority benefit of Chinese Patent Application No. CN202310579866.1, filed on May 22, 2023, the full disclosure of which is incorporated herein by reference.

### BACKGROUND

### Technical Field

The present application relates to transmission methods and devices in wireless communication systems, relating to the acquisition of system information blocks and energy saving.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72th plenary decided to conduct a study of New Radio (NR), or what is called fifth Generation (5G). A work Item (WI) of NR was approved at 3GPP RAN #75th plenary to start standardization work on NR. In communications, whether Long Term Evolution (LTE) or 5G NR involves features of accurate

reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIOT), Vehicular to X (V2X), Device to Device communications, Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast and unicast, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

3GPP standardization organization has done relevant standardization work for 5G and formed a series of standards. The standard contents can be referred to:
https://www.3gpp.org/ftp/Specs/archive/38_series/38.321/38321-h00.zip
https://www.3gpp.org/ftp/Specs/archive/38_series/38.331/38331-h00.zip

### SUMMARY

In wireless communication systems, acquiring system information blocks is very important function, some system information blocks are always broadcast but some system information blocks are based on request from nodes. Researchers have found that nodes in RRC_CONNECTED state may not be able to transmit signals used for requesting system information blocks in a timely manner using existing techniques at a time other than the downlink reception time and/or uplink transmission time determined by a first parameter set, resulting in an inability to update system information in a timely manner, which negatively affects the communication and may even lead to dropping of the line. Researchers have further found that the network's determination of the downlink reception time and/or uplink transmission time of the terminal by a first parameter set facilitates electricity saving of the network, i.e., the network can refrain from transmitting or reduce transmitting downlink signals at a time other than the downlink reception time, and refrain from receiving or reduce receiving uplink signals at a time other than the uplink transmission time: however, if the performance of the terminal is seriously affected it cannot be received, so ensuring that the performance of the terminal is not significantly affected is the key to implementing the above method for the network electricity saving. Researchers have also found that with electricity-saving methods, the network that still guarantees RRC_IDLE state, RRC_INACTIVE state, and timely access to system information blocks by legitimate end devices is unfair to terminals in RRC_CONNECTED state that support the latest version of the protocol, and this issue also needs to be addressed.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict. Meanwhile, the method proposed in the present application can also be used to solve other communication problems, such as related problems encountered in evolving mobile communication systems.

The present application provides a method in a first node for wireless communications, comprising:
transmitting a first signal, the first signal indicating a request for a first system information block; and
receiving a first system information block transmitted by broadcast;
herein, the first node is in RRC_CONNECTED state; whether the first signal is a signal transmitted on a PRACH or an RRC message occupying a CCCH in a random access procedure or an RRC message occupying a DCCH is dependent on a first parameter set; at least a latter of a downlink reception time and an uplink transmission time is dependent on the first parameter set; the meaning of whether the first signal is a signal transmitted on a PRACH or an RRC message occupying a CCCH in a random access procedure or an RRC message occupying a DCCH is dependent on a first parameter set comprises: when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH.

In one embodiment, a problem to be solved in the present application comprises: how a node in RRC_CONNECTED state can get a system information block that needs to be requested before it is transmitted; how to use different methods to acquire system information blocks in different situations; how to acquire system information blocks based on an uplink transmission time and/or downlink reception time determined by a first parameter set; how to save electricity; how to ensure fairness.

In one embodiment, advantages of the above method comprise: saving electricity, ensuring fairness, timely access to system information blocks, lower latency, and greater robustness.

Specifically, according to one aspect of the present application, T311 timer is not running.

Specifically, according to one aspect of the present application, the first node only receives a paging message within the downlink reception time.

Specifically, according to one aspect of the present application, SIB1 is received, and the SIB1 indicates that a first system information block is notBroadcasting;
herein, the first node does not store a valid first system information block; the first node's not storing a valid first system information block triggers transmitting a first signal.

Specifically, according to one aspect of the present application, a first signaling signal is received, the first signaling is DCI, the first signaling indicates activating the first parameter set, a first RNTI scrambles the first signaling, and the first RNTI is an RNTI other than an SI-RNTI, a G-RNTI, a PS-RNTI, and a C-RNTI; herein, the first signaling is transmitted on a PDCCH.

Specifically, according to one aspect of the present application, the first node only monitors an SPS occasion within the downlink reception time; the first node only performs a transmission on a CG occasion within the uplink transmission time; the first node only transmits an SR within the uplink transmission time.

Specifically, according to one aspect of the present application, whether the first node monitors an SPS occasion is unrelated to whether the first node is in an active time of a discontinuous reception (DRX).

Specifically, according to one aspect of the present application, whether the first node performs a transmission on a CG occasion is unrelated to whether the first node is in an active time of a DRX.

Specifically, according to one aspect of the present application, a time while a first timer is running is a time other than the uplink transmission time; the first timer is only running after being configured with a first parameter set; the meaning of when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH is: when the first timer is running, the first signal is a signal transmitted on a PRACH or an RRC message occupying a CCCH in a random access procedure, and when the first timer is not running, the first signal is an RRC message occupying a DCCH.

Specifically, according to one aspect of the present application, the first node is an IoT terminal.

Specifically, according to one aspect of the present application, the first node is a UE.

Specifically, according to one aspect of the present application, the first node is a relay.

Specifically, according to one aspect of the present application, the first node is an access network device.

Specifically, according to one aspect of the present application, the first node is a vehicle terminal.

Specifically, according to one aspect of the present application, the first node is an aircraft.

Specifically, according to one aspect of the present application, the first node is a mobile phone.

The present application provides a first node for wireless communications, comprising:
a first transmitter, transmitting a first signal, the first signal indicating a request for a first system information block; and
a first receiver, receiving a first system information block transmitted by broadcast;
herein, the first node is in RRC_CONNECTED state; whether the first signal is a signal transmitted on a PRACH or an RRC message occupying a CCCH in a random access procedure or an RRC message occupying a DCCH is dependent on a first parameter set; at least a latter of a downlink reception time and an uplink transmission time is dependent on the first parameter set; the meaning of whether the first signal is a signal transmitted on a PRACH or an RRC message occupying a CCCH in a random access procedure or an RRC message occupying a DCCH is dependent on a first parameter set comprises: when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH.

In one embodiment, the present application has the following advantages over conventional schemes:
helping the UE in RRC_CONNECTED state to acquire system information blocks in a more timely manner and to request system information blocks even when it is not possible to transmit information over a DCCH;
ensuring the fairness;
with low complexity and low development costs;
being more flexible, providing more implementation possibilities for networks or base stations;
being conducive to saving electricity on the network.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmitting a first signal and receiving a first system information block transmitted by broadcast according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of a downlink reception time according to one embodiment of the present application;

FIG. 7 illustrates a schematic diagram of an uplink transmission time according to one embodiment of the present application;

FIG. 8 illustrates a schematic diagram of DRX according to one embodiment of the present application;

FIG. 9 illustrates a schematic diagram of at least a latter of a downlink reception time and an uplink transmission time depending on a first parameter set according to one embodiment of the present application;

FIG. 10 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

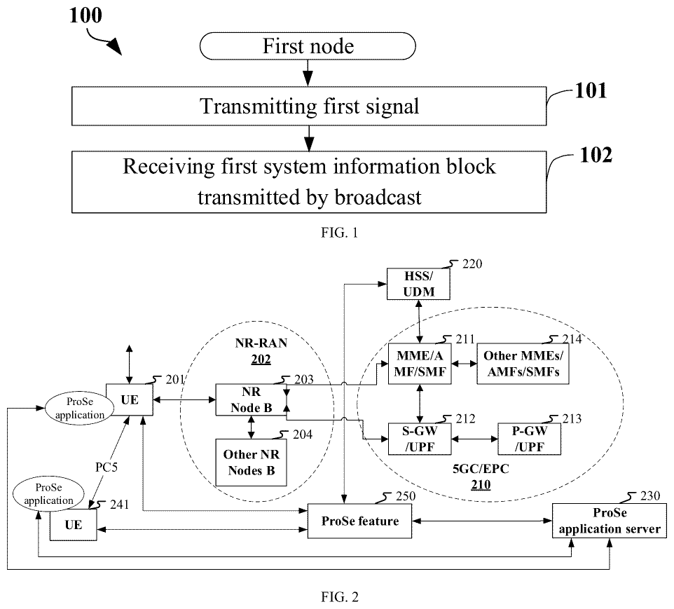

Embodiment 1 illustrates a flowchart of transmitting a first signal and receiving a first system information block transmitted by broadcast according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application transmits a first signal in step 101, and receives a first system information block transmitted by broadcast in step 102.
herein, the first signal indicates a request for a first system information block; the first node is in RRC_CONNECTED state; whether the first signal is a signal transmitted on a PRACH or an RRC message occupying a CCCH in a random access procedure or an RRC message occupying a DCCH is dependent on a first parameter set; at least a latter of a downlink reception time and an uplink transmission time is dependent on the first parameter set; the meaning of whether the first signal is a signal transmitted on a PRACH or an RRC message occupying a CCCH in a random access procedure or an RRC message occupying a DCCH is dependent on a first parameter set comprises: when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH.

In one embodiment, the first node is a User Equipment (UE).

In one embodiment, interpretations of the terminology in the present application refer to definitions given in TS38 series of 3GPP specification protocols.

In one embodiment, the first node is in RRC_CONNECTED state.

In one embodiment, the method proposed in the present application is not related to sidelink communications.

In one embodiment, the method proposed in the present application is applied to direct communications between the terminal and the network.

In one embodiment, a serving cell refers to a cell where a UE camps; executing a cell search comprises: the UE searches for a suitable cell of a selected Public Land Mobile Network (PLMN) or a Stand-alone Non-Public Network (SNPN), selects the suitable cell to provide available services, and monitors a control channel of the suitable cell, and this procedure is defined as camping on a cell; that is, a camped cell is a serving cell of the UE relative to the UE. Advantages of camping on a cell in RRC_IDLE state or RRC_INACTIVE state are: enabling the UE to receive system information from the PLMN or the SNPN; after registration, if the UE wishes to establish an RRC connection or continue a suspended RRC connection, the UE can achieve this by executing an initial access on a control channel of a camped cell; the network may page the UE; so that the UE can receive notifications of Earthquake and Tsunami Warning System (ETWS) and Commercial Mobile Alert System (CMAS).

In one embodiment, for a UE in RRC_CONNECTED state that is not configured with carrier aggregation/dual connectivity (CA/DC), only one serving cell comprises a PCell. For a UE in RRC_CONNECTED state that is configured with CA/DC, a serving cell is used to indicate a cell set comprising a Special Cell (SpCell) and all sub-cells. The PCell is a cell in a Master Cell Group (MCG), which works at primary frequency, and the UE executes an initial connection establishment procedure or initiates a connection re-establishment on the PCell. For a dual connectivity operation, a Secondary Cell Group (SCG) refers to a PCell of an MCG or a Primary SCG Cell (PSCell) of an SCG; if it is not a dual connectivity operation, an SpCell refers to a PCell.

In one embodiment, a frequency at which a Secondary Cell (SCell) operates is sub-frequency.

In one embodiment, an individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in MR-DC, a radio access node providing a control-plane connection to the core network is a master node, and the master node may be a master eNB, a master ng-eNB, or a master gNB.

In one embodiment, an MCG refers to, in MR-DC, a group of serving cells associated with a master node, comprising an SpCell, and optionally one or multiple SCells.

In one embodiment, a PCell is an SpCell of an MCG.

In one embodiment, a PSCell is an SpCell of an SCG.

In one embodiment, in MR-DC, a control plane connection to the core network is not provided, and a radio access node providing extra resources to the UE is a sub-node. The sub-node can be an en-gNB, a sub-ng-eNB or a sub-gNB.

In one embodiment, in MR-DC, a group of serving cells associated with a sub-node is a Secondary Cell Group (SCG), comprising an SpCell and, optionally, one or multiple SCells.

In one embodiment, the first node is configured or only configured an MCG.

In one subembodiment of the embodiment, an MCG of the first node comprises at least one SCell.

In one subembodiment of the embodiment, an MCG of the first node does not comprise an SCell.

In one embodiment, an RRC information block refers to an information element in an RRC message.

In one embodiment, SSB can be referred to as SS/PBCH, or SS block.

In one embodiment, a Synchronization Signal and PBCH block (SSB) comprises a primary synchronization signal and a secondary synchronization signal, and the primary synchronization signal and the secondary synchronization signal as well as the PBCH occupy fixed time-frequency resources.

In one embodiment, a PBCH bears a master information block (MIB), and the MIB indicates key information required to access the system, comprising system frame number.

In one subembodiment of the embodiment, MIB carries information required to receive SIB1.

In one subembodiment of the embodiment, an MIB determines a common control resource set.

In one subembodiment of the embodiment, an MIB indicates a common subcarrier spacing.

In one subembodiment of the embodiment, an MIB indicates whether a cell is barred.

In one embodiment, an SS/PBCH is used for measurement.

In one embodiment, the first system information block is a system information block other than SIB1 (system information block 1).

In one embodiment, the first system information block is a system information block other than MIB.

In one embodiment, in NR system, the acquisition of SIB1 and MIB is not dependent on the request.

In one embodiment, in NR system, SIB1 and MIB are both actively transmitted.

In one embodiment, the first signal is an uplink signal.

In one embodiment, the meaning of the first signal indicates requesting a first system information block is or comprises: the first signal triggers the network to transmit a first system information block.

In one embodiment, the meaning of the first signal indicates requesting a first system information block is or comprises: the first signal requests the network to transmit a first system information block.

In one embodiment, the meaning of the first signal indicates requesting a first system information block is or comprises: the first signal is or comprises an rrcSystemInfoRequest message.

In one subembodiment of the embodiment, the rrcSystemInfoRequest message is transmitted on a CCCH (common control channel).

In one subembodiment of the embodiment, the rrcSystemInfoRequest is an RRC message.

In one embodiment, the meaning of the first signal indicates requesting a first system information block is or comprises: the first signal is transmitted on random access resources configured to request a system information block.

In one embodiment, the meaning of the first signal indicates requesting a first system information block is or comprises: the first signal indicates which system information blocks are requested; the first system information block belongs to which of the system information blocks.

In one embodiment, the meaning of a first system information block transmitted by broadcast is or comprises: the first system information block is transmitted by broadcast.

In one embodiment, the meaning of a first system information block transmitted by broadcast is or comprises: the first system information block is transmitted not through unicast.

In one embodiment, the meaning of a first system information block transmitted by broadcast is or comprises: the first system information block is not carried by an RRCReconfiguration message.

In one embodiment, the meaning of a first system information block transmitted by broadcast is or comprises: the first system information block is not transmitted to a specific UE.

In one embodiment, the meaning of a first system information block transmitted by broadcast is or comprises: the first system information block is transmitted not through a dedicated channel.

In one embodiment, the meaning of a first system information block transmitted by broadcast is or comprises: the first system information block is transmitted not through a dedicated control channel (DCCH).

In one embodiment, the meaning of a first system information block transmitted by broadcast is or comprises: the first system information block is transmitted through a BCCH (broadcast control channel).

In one embodiment, the meaning of a first system information block transmitted by broadcast is or comprises: the first system information block is transmitted in RLC transparent mode.

In one embodiment, the fact that a system information block is transmitted in a non-broadcast manner means that the system information block is transmitted in a dedicated manner.

In one embodiment, the fact that a system information block is transmitted using a non-broadcast means that the system information block is transmitted using an RRCReconfiguration message.

In one embodiment, the fact that a system information block is transmitted in a non-broadcast manner means that the system information block uses a DCCH.

In one embodiment, the fact that a system information block is transmitted in a non-broadcast manner means that the system information is for specific UE.

In one embodiment, a UE in RRC_CONNECTED state supports the following functions or features: the UE stores the access layer context, transmits unicast data, and transmits MBS (multicast broadcast service) multicast data, and SCG can be used for a UE that support dual connectivity; for a UE using carrier aggregation, an SCell can be used to provide channel quality information, which can be configured for DRX of the UE and the network control mobility.

In one embodiment, RRC_CONNECTED state is an RRC state other than RRC_IDLE state and RRC_INACTIVE state.

In one embodiment, the signal transmitted on a PRACH comprises Preamble.

In one embodiment, the signal transmitted on a PRACH comprises a specific sequence.

In one embodiment, the signal transmitted on a PRACH comprises a signal generated by random sequence.

In one embodiment, the signal transmitted on a PRACH comprises msg1.

In one embodiment, the signal transmitted on a PRACH comprises a random access signal.

In one embodiment, a signal transmitted on PRACH comprises a random access signal generated by a short sequence.

In one embodiment, a signal transmitted on PRACH comprises a random access signal generated by a long sequence.

In one embodiment, an RRC message occupying a CCCH in the random access procedure comprises: msg3.

In one embodiment, an RRC message occupying a CCCH in the random access procedure comprises: MSGA.

In one embodiment, an RRC message occupying a CCCH in the random access procedure comprises: a message transmitted on a PUSCH (physical uplink shared channel) in MSGA.

In one embodiment, an RRC message occupying a CCCH in the random access procedure comprises: rrcSystemInfoRequest.

In one embodiment, an RRC message occupying a CCCH in the random access procedure comprises: rrcPosSystemInfoRequest.

In one embodiment, an RRC message occupying a CCCH in the random access procedure comprises: rrcSystemInfoRequest1.

In one embodiment, an RRC message occupying a CCCH in the random access procedure comprises: messages in 4-step random access procedure.

In one embodiment, an RRC message occupying a CCCH in the random access procedure comprises: messages in 2-step random access procedure.

In one embodiment, an RRC message occupying a CCCH in the random access procedure comprises: an RRC message occupying CCCH and CCCH1.

In one embodiment, an RRC message occupying a CCCH in the random access procedure comprises: an RRC message transmitted on SRB0.

In one embodiment, the meaning of the RRC message occupying a DCCH comprises: not belonging to random access procedure.

In one embodiment, advantages of a first signal not belonging to the random access process in the above embodiments are that it is more flexible and faster, and can be transmitted without initiating random access.

In one embodiment, the meaning of the RRC message occupying a DCCH comprises: belonging to a random access procedure.

In one embodiment, advantages of transmitting a first signal in a random access in the above embodiments are that it is safer than transmitting with a CCCH in random access.

In one embodiment, the meaning of the RRC message occupying a DCCH comprises: an RRC message transmitted on SRB1.

In one embodiment, the meaning of the RRC message occupying a DCCH comprises: DedicatedSIBRequest.

In one embodiment, the meaning of the RRC message occupying a DCCH comprises: UEAssistanceInformation.

In one embodiment, the meaning of the RRC message occupying a DCCH comprises: DedicatedSIBRequestNR.

In one embodiment, the meaning of the RRC message occupying a DCCH comprises: DedicatedPosSIBRequest.

In one embodiment, the meaning of the RRC message occupying a DCCH comprises: transmitting using confirmation mode of RLC.

In one embodiment, an RRC information block can comprise one or multiple RRC information blocks.

In one embodiment, an RRC information block may not comprise any RRC information block, but only comprises at least one parameter.

In one embodiment, a radio bearer comprises at least a signaling radio bearer and a data radio bearer.

In one embodiment, a radio bearer comprises an MBS (multicast broadcast service) radio bearer.

In one embodiment, a radio bearer is services or an interface of services provided by the PDCP layer to higher layer.

In one subembodiment of the above embodiment, the higher layer comprises one of the RRC layer, the NAS layer, and the SDAP layer.

In one embodiment, a signaling radio bearer is services or an interface to services provided by the PDCP to higher layer for signaling transmission.

In one subembodiment of the above embodiment, the higher layer comprises at least former of the RRC layer and the NAS.

In one embodiment, a data radio bearer is services or an interface to services provided by the PDCP to higher layer for data transmission.

In one subembodiment of the above embodiment, the higher layer comprises at least former of the SDAP layer and the NAS.

In one embodiment, the first node is not a legacy UE.

In one embodiment, a signaling supported by the legitimate device is a signaling prior to 3GPP release 18.

In one embodiment, a signaling supported by the legitimate device is a signaling of 3GPP release 17 or prior to release 17.

In one embodiment, a signaling supported by the legitimate device is a signaling supported by the device produced before the submission of the present application.

In one embodiment, the uplink transmission time and the downlink reception time are for a first cell.

In one embodiment, the first cell is a serving cell of the first node.

In one embodiment, the first cell is a non-serving cell of the first node.

In one embodiment, the first cell is an adjacent cell of the first node.

In one embodiment, the first cell is an SPCell of the first node.

In one embodiment, the first cell is a PCell of the first node.

In one embodiment, the first cell is a PSCell of the first node.

In one embodiment, the first cell is an SCell of the first node.

In one embodiment, the first cell is activated.

In one embodiment, the first cell is always activated.

In one embodiment, the first cell is a target receiver of the first signal.

In one subembodiment of the embodiment, the first cell is a transmitter of a first system information block.

In one subembodiment of the above embodiment, the first signal occupies resources of the first cell.

In one subembodiment of the above embodiment, the target receiver refers to the first signal being transmitted to the first cell.

In one subembodiment of the embodiment, the first cell is not a transmitter of a first system information block.

In one subembodiment of the above embodiment, a transmitter of the first system information block is an SCell, and the first cell is a PCell.

In one subembodiment of the above embodiment, a transmitter of the first system information block is a PSCell, and the first cell is a PCell.

In one subembodiment of the above embodiment, a transmitter of the first system information block is a PCell, and the first cell is an SCell or a PSCell.

In one embodiment, the first cell is a transmitter of a first system information block.

In one subembodiment of the above embodiment, the first cell is not a receiver of the first signal.

In one subembodiment of the above embodiment, the first cell is a receiver of the first signal.

In one subembodiment of the above embodiment, the first cell is a PCell, and a receiver of the first signal is an SCell or a PSCell.

In one embodiment, the first system information block is one of SIB2, SIB3, SIB4, SIB5.

In one embodiment, the first system information block is one of SIB6, SIB7, SIB8

In one embodiment, the first system information block is one of SIB9, SIB10, SIB11, SIB13, SIB14, SIB15, SIB16, SIB17, SIB18, SIB19.

In one embodiment, the first system information block is SIB20.

In one embodiment, the first system information block is SIB21.

In one embodiment, the first system information block is SIB22.

In one embodiment, the first system information block is indicated by SIB1 as not broadcasting.

In one embodiment, the first parameter set comprises at least one parameter.

In one embodiment, the first parameter set comprises at least two parameters.

In one embodiment, the first parameter set comprises at least a first time length.

In one embodiment, the first parameter set comprises at least a first period.

In one embodiment, the first period comprises a period of the uplink transmission time.

In one embodiment, the first period comprises a period of the downlink reception time.

In one embodiment, the first time length comprises a time length allowed for uplink transmission within any time determined by the first period.

In one embodiment, the first time length comprises a time length for a downlink reception to be carried out within any time determined by the first period.

In one embodiment, the first time length comprises a first time offset.

In one embodiment, the first time offset is a time offset of a start of a time allowed for an uplink transmission to be carried out relative to a start of a period determined by any the first period.

In one embodiment, the first time offset is a time offset of a start of a time allowed for a downlink reception to be carried out relative to a start of a period determined by any the first period.

In one embodiment, the first parameter set is used to indicate the first cell.

In one embodiment, the first parameter set is applied to the first cell.

In one embodiment, the first parameter set is used to indicate entering a first state.

In one embodiment, the first parameter set is used to indicate that at least the first cell enters a first state.

In one embodiment, the first parameter set is parameters related to the first state.

In one embodiment, the first state corresponds to a receiving and/or transmitting mode of a network.

In one embodiment, the first state is related to network power saving.

In one embodiment, the first state is related to different signal transmission methods.

In one embodiment, the first state is related to different signal reception methods.

In one embodiment, the first state is related to transmission and/or reception methods of different reference signals.

In one embodiment, the first state is related to whether dynamic scheduling is supported.

In one embodiment, the first state is related to allocation methods of different reference signal resources.

In one embodiment, the first state is related to different transmit power.

In one embodiment, the first state is related to transmission frequency of different broadcast signals.

In one embodiment, the first state is related to whether a broadcast signal is transmitted.

In one embodiment, the first state is related to whether to an SSB (synchronization signal block) is transmitted.

In one embodiment, the first state is related to whether to SIB1 (System Information Block1) is transmitted.

In one embodiment, the first state is unrelated to whether a single terminal is in the DRX group's active time.

In one embodiment, the first state is related to a transmission mode of a PDCCH.

In one embodiment, a feature of a cell being in the first state comprises the closure of data transmission based on dynamic scheduling in the cell.

In one embodiment, a feature of a cell being in the first state comprises the cell stopping dynamic scheduling.

In one embodiment, a feature of a cell being in the first state comprises the cell stopping any transmission.

In one embodiment, a feature of a cell being in the first state comprises the cell stopping transmission of any data.

In one embodiment, a feature of a cell being in the first state comprises the cell stopping semi-persistent scheduling.

In one embodiment, the first state is a state of network energy saving.

In one embodiment, the first state is a DTX (discontinuous transmission) state of a cell.

In one embodiment, the first state is a state when a DTX of a cell is inactive.

In one embodiment, the first state is a DRX state of a cell.

In one embodiment, the first state is a state when a DRX of a cell is inactive.

In one embodiment, the first state is a DRX state and a DTX state of a cell.

In one embodiment, the first state is a state of not receiving and/or not transmitting in a cell.

In one embodiment, the uplink transmission time is a time allowed for transmitting an uplink signal.

In one embodiment, the downlink reception time is a time for monitoring a downlink dynamic scheduling.

In one embodiment, the first parameter set is indicated by non-unicast.

In one embodiment, the first parameter set is indicated by broadcast.

In one embodiment, the first parameter set is indicated by a system information block.

In one embodiment, the first parameter set is indicated by DCI.

In one embodiment, the first parameter set is indicated by a MAC CE.

In one embodiment, the first parameter set is not indicated by the first signaling.

In one embodiment, the uplink transmission time coincides with the downlink reception time.

In one embodiment, the uplink transmission time does not coincide with the downlink reception time.

In one embodiment, the uplink transmission time is partially overlapping with the downlink reception time.

In one embodiment, the uplink transmission time is not overlapping with the downlink reception time.

In one embodiment, the meaning of at least one of a downlink reception time and an uplink transmission time depends on the first parameter set comprises: the first parameter set indicates the downlink reception time.

In one subembodiment of the above embodiment, the downlink reception time is adjusted.

In one subembodiment of the above embodiment, the downlink reception time is adjusted before and after being indicated the first parameter set.

In one embodiment, the meaning of at least one of a downlink reception time and an uplink transmission time depends on the first parameter set comprises: the first parameter set indicates the uplink transmission time.

In one subembodiment of the above embodiment, the uplink transmission time is adjusted.

In one subembodiment of the above embodiment, the uplink transmission time is adjusted before and after being indicated the first parameter set.

In one embodiment, the meaning of at least one of a downlink reception time and an uplink transmission time depends on the first parameter set comprises: the downlink reception time is determined by the first parameter set.

In one embodiment, the meaning of at least one of a downlink reception time and an uplink transmission time depends on the first parameter set comprises: the uplink transmission time is determined by the first parameter set.

In one embodiment, the meaning of at least one of a downlink reception time and an uplink transmission time depends on the first parameter set comprises: it is necessary to perform a downlink reception based on the first parameter set.

In one embodiment, the meaning of at least one of a downlink reception time and an uplink transmission time depends on the first parameter set comprises: it is necessary to perform an uplink transmission based on the first parameter set.

In one embodiment, the first parameter set is used to determine at least one of a downlink reception time and an uplink transmission time of the first cell.

In one embodiment, the uplink transmission time comprises at least one time window.

In one embodiment, the uplink transmission time comprises multiple discontinuous time windows.

In one embodiment, the uplink transmission time comprises multiple time windows, and each interval between any two adjacent time windows among the multiple time windows comprised in the uplink transmission time is equal.

In one embodiment, the downlink reception time comprises at least one time window.

In one embodiment, the downlink reception time comprises multiple discontinuous time windows.

In one embodiment, the downlink reception time comprises multiple time windows, and each interval between any adjacent time windows among the multiple time windows comprised in the downlink reception time is equal.

In one embodiment, the meaning of not being indicated a first parameter set comprises: not receiving the first parameter set.

In one embodiment, the meaning of not being indicated a first parameter set comprises: the first parameter set is not established.

In one embodiment, the meaning of not being indicated a first parameter set comprises: the first parameter set is released.

In one embodiment, the meaning of not being indicated a first parameter set comprises: the first parameter set is not valid.

In one embodiment, the meaning of not being indicated a first parameter set comprises: the first parameter set is not used.

In one embodiment, the RRC message occupying a DCCH does not belong to any random access procedure.

In one embodiment, the meaning of receiving the first parameter set comprises that the received first parameter set is activated.

In one embodiment, the meaning of receiving the first parameter set comprises that the received first parameter set is established.

In one embodiment, the meaning of receiving the first parameter set comprises that the received first parameter set is deactivated.

In one embodiment, the meaning of not receiving the first parameter set comprises that the received first parameter set is not activated.

In one embodiment, the meaning of receiving the first parameter set comprises that the received first parameter set is released.

In one embodiment, a message used to configure the first parameter set is an RRC message.

In one embodiment, the first parameter set is configured through unicast.

In one embodiment, a message configuring the first parameter set is transmitted on a dedicated channel.

In one embodiment, a message used to configure the first parameter set is an RRCReconfiguration message.

In one embodiment, the uplink transmission time is a DRX time of a cell.

In one embodiment, the uplink transmission time corresponds to a DRX time of a cell.

In one embodiment, the uplink transmission time is or corresponds to a DRX time of a master cell.

In one embodiment, the downlink reception time is a discontinuous transmission time of a cell.

In one embodiment, the downlink reception time corresponds to a discontinuous transmission time of a cell.

In one embodiment, the downlink reception time is or corresponds to a discontinuous transmission time of a master cell.

In one embodiment, the security of the first node has been activated.

In one embodiment, a signal transmitted on a PRACH and an RRC message occupying a CCCH in random access procedure are not encrypted.

In one embodiment, a CCCH is a logical channel.

In one embodiment, SRB0 (signaling radio bearer 0) used for transmitting an RRC messages uses a CCCH logical channel.

In one embodiment, SRB1 (signaling radio bearer 1) used for transmitting an RRC messages uses a DCCH logical channel.

In one embodiment, an RRC message occupying a CCCH is transmitted using SRB0.

In one embodiment, an RRC message occupying a DCCH is encrypted.

In one embodiment, an RRC message occupying a DCCH is transmitted using SRB1.

In one embodiment, an RRC message occupying a CCCH is a UL-CCCH message.

In one embodiment, an RRC message occupying a DCCH is a UL-DCCH message.

In one embodiment, the first node receives a first system information block within the downlink reception time.

In one embodiment, the first node receives a first system information block outside the downlink reception time.

In one embodiment, the first node receives a first system information block within the uplink transmission time.

In one embodiment, the first node receives a first system information block outside the uplink transmission time.

In one embodiment, the receiving a first system information block is executed after the first signal is transmitted.

In one subembodiment of the embodiment, a transmission time of a first system information block depends on the network implementation.

In one subembodiment of the embodiment, a transmission time of a first system information block is unrelated to the downlink reception time.

In one subembodiment of the embodiment, a transmission time of a first system information block is unrelated to the uplink transmission time.

In one embodiment, the uplink transmission time corresponds to a DRX time of at least one cell.

In one subembodiment of the above embodiment, the at least one cell comprises the first cell.

In one subembodiment of the above embodiment, the at least one cell comprises a PCell of the first node.

In one embodiment, the downlink reception time corresponds to a discontinuous transmission time of at least one cell.

In one subembodiment of the above embodiment, the at least one cell comprises the first cell.

In one subembodiment of the above embodiment, the at least one cell comprises a PCell of the first node.

In one embodiment, the meaning of whether the first signal is a signal transmitted on a PRACH or an RRC message occupying a CCCH in a random access procedure or an RRC message occupying a DCCH is dependent on a first parameter set comprises: when the first parameter set is received and outside the downlink reception time, the first signal is a signal transmitted on a PRACH or an RRC message occupying a CCCH in a random access procedure, when the first parameter set is not received, the first signal is an RRC message occupying a DCCH; when the first parameter set is received and within the downlink reception time, the first signal is an RRC message occupying a DCCH.

In one embodiment, the uplink transmission time and a DRX of the first node are independently configured.

In one embodiment, the uplink transmission time is unrelated to an active time of a DRX of the first node.

In one embodiment, the uplink transmission time overlaps but does not coincide with an active time of a DRX of the first node.

In one embodiment, the uplink transmission time is not overlapping with an active time of a DRX of the first node.

In one embodiment, the downlink reception time and a DRX of the first node are independently configured.

In one embodiment, the downlink reception time is unrelated to an active time of a DRX of the first node.

In one embodiment, the downlink reception time overlaps but does not coincide with an active time of a DRX of the first node.

In one embodiment, the downlink reception time is not overlapping with an active time of a DRX of the first node.

In one embodiment, when the first signal is a signal transmitted on a PRACH or an RRC message occupying a CCCH in a random access procedure, whether the first signal is a signal transmitted on a PRACH or an RRC message occupying a CCCH in a random access procedure depends on the network's indication or configuration.

In one embodiment, when the first signal is a signal transmitted on a PRACH or an RRC message occupying a CCCH in a random access procedure, whether the first signal is a signal transmitted on a PRACH or an RRC message occupying a CCCH in a random access procedure depends on the implementation of the first node.

In one subembodiment of the embodiment, the first node randomly determines whether the first signal is a signal transmitted on a PRACH or an RRC message occupying a CCCH in a random access procedure.

In one subembodiment of the embodiment, when the first node only requests a first system information block, the first signal is a signal transmitted on a PRACH, and when the first node also requests other system information blocks, the first signal is an RRC message occupying a CCCH in random access procedure.

In one subembodiment of the embodiment, when a signal transmitted on a PRACH is used to request a system information block, only one type of system information block can be requested at a time; when an RRC message transmitted on a CCCH in a random access procedure is used to request a system information block, multiple system information blocks can be requested at once.

In one subembodiment of the embodiment, the first node determines whether the first signal is a signal transmitted on a PRACH or an RRC message occupying a CCCH in a random access procedure according to resource configuration of a PRACH; when resources configured to a signal transmitted on a PRACH used to request a system information block are earlier than resources configured to an RRC message on a CCCH in random access procedure, the first signal is a signal transmitted on a PRACH; when resources configured to a signal transmitted on a PRACH used to request a system information block are later than resources configured to an RRC message on a DCCH, the first signal is an RRC message transmitted on a CCCH in a random access procedure; this is beneficial for transmitting the first signal as soon as possible.

In one subembodiment of the embodiment, the first node determines whether the first signal is a signal transmitted on a PRACH or an RRC message occupying a CCCH in a random access procedure according to resource configuration of a PRACH; when resources configured to a signal transmitted on a PRACH used to request a system information block are earlier than resources configured to a random access procedure supporting a transmission of an RRC message on a CCCH, the first signal is a signal transmitted on a PRACH; when resources configured to a signal transmitted on a PRACH used to request a system information block are later than resources configured to a random access procedure supporting a transmission of an RRC message on a CCCH, the first signal is an RRC message transmitted on a CCCHD in a random access procedure; this is beneficial for transmitting the first signal as soon as possible.

In one embodiment, a logical channel is services or an interface of services provided by the MAC to the RLC layer.

In one embodiment, MAC provides multiple data transmission services; each logical channel type is defined by what type of information is being transmitted; logical channels are divided into two groups: control channel and traffic channel, where the control channel is used only for transmitting control-plane information, including a BCCH used for transmitting control information of broadcast system, the BCCH being a downlink channel, including a PCCH (paging control channel) used for bearing paging messages, the PCCH also being a downlink channel, including a CCCH used for transmitting control information between the UE and the network, the CCCH mainly being used when there is no RRC connection, including a DCCH used for transmitting dedicated control information between the UE and the network, the DCCH being a point-to-point bi-directional channel mainly used when the UE has an RRC connection.

In one embodiment, the first parameter set is carried by a field whose name comprises NES in an RRC message.

In one embodiment, the first parameter set is carried by a field whose name comprises DTX in an RRC message.

In one embodiment, the first parameter set is carried by a field whose name comprises DRX in an RRC message.

In one embodiment, advantages of the above three embodiments are that the function of the first parameter set is better indicated and the development cost is reduced.

In one embodiment, T311 timer is not running.

In one embodiment, T311 timer is not running when the first signal is transmitted.

In one embodiment, a start condition of T311 timer is initiating an RRC connection re-establishment.

In one embodiment, an expiration of T311 timer triggers entering into RRC_IDLE state.

In one embodiment, a stopping condition for T311 timer comprises selecting a suitable cell.

In one embodiment, RRC re-establishment is not executed in the first node.

In one embodiment, an RRC connection re-establishment is not executed in the first node.

In one embodiment, the first node only receives a paging message within the downlink reception time.

In one embodiment, the downlink reception time comprises multiple discontinuous time windows, where a time interval between two adjacent time windows is less than a DRX (discontinuous reception) period configured to the first node.

In one embodiment, a DRX comprises an eDRX (extended DRX).

In one embodiment, the first node only monitors an SPS (semi-persistent scheduling) occasion within the downlink reception time.

In one subembodiment of the above embodiment, the first node does not receive or monitor an SPS occasion at a time outside the downlink reception time.

In one subembodiment of the above embodiment, the first node only receives or monitors an SPS occasion within the downlink reception time.

In one embodiment, the first node only transmits on a CG (configured grant) occasion within the uplink transmission time.

In one subembodiment of the above embodiment, the first node only executes a transmission on a CG occasion within the uplink transmission time.

In one embodiment, the first node only transmits an SR (scheduling request) within the uplink transmission time.

In one embodiment, the first node does not transmit an SR outside the uplink transmission time.

In one embodiment, at a time outside the uplink transmission time, the failure to transmit an SR cannot trigger a random access.

In one embodiment, whether the first node monitors an SPS occasion is unrelated to whether the first node is in an active time of a DRX.

In one embodiment, the meaning of whether the first node monitors an SPS occasion is unrelated to whether the first node is in an active time of a DRX comprises: whether the first node monitors an SPS occasion depends solely on a condition other than a DRX of the first node.

In one embodiment, the meaning of whether the first node monitors an SPS occasion is unrelated to whether the first node is in an active time of a DRX comprises: an SPS occasion monitored by the first node can be outside an active time of a DRX of the first node, or within an active time of a DRX of the first node.

In one embodiment, the meaning of whether the first node monitors an SPS occasion is unrelated to whether the first node is in an active time of a DRX comprises: when within the downlink reception time, the first node monitors an SPS occasion, regardless of whether an SPS occasion is within an active time of a DRX of the first node or outside the active time of DRX of the first node.

In one embodiment, the meaning of whether the first node monitors an SPS occasion is unrelated to whether the first node is in an active time of a DRX comprises: when it is outside the downlink reception time, the first node does not monitor an SPS occasion, even if the SPS occasion is within an active time of a DRX of the first node.

In one embodiment, whether the first node performs a transmission on a CG occasion is unrelated to whether the first node is in an active time of a DRX.

In one embodiment, the meaning of whether the first node performs a transmission on a CG occasion is unrelated to whether the first node is in an active time of a DRX comprises: whether the first node performs a transmission on a CG occasion depends solely on a condition other than a DRX of the first node.

In one embodiment, the meaning of whether the first node performs a transmission on a CG occasion is unrelated to whether the first node is in an active time of a DRX comprises: the first node can perform a transmission on a CG occasion outside an active time of a DRX of the first node, or within an active time of a DRX of the first node.

In one embodiment, the meaning of whether the first node monitors an SPS occasion is unrelated to whether the first node is in an active time of a DRX comprises: when within the uplink transmission time, the first node performs a transmission on a CG occasion, regardless of whether the CG occasion is within an active time of a DRX of the first node or outside active time of DRX of the first node.

In one embodiment, the meaning of whether the first node monitors an SPS occasion is unrelated to whether the first node is in an active time of a DRX comprises: when it is outside the uplink transmission time, the first node does not perform a transmission on a CG occasion, even if the CG occasion is within an active time of a DRX of the first node.

In one embodiment, the first node transmits a first signal, and the first signal indicates a request for a first system information block; the first node receives a first system information block transmitted by broadcast; the first node is in RRC_CONNECTED state; whether the first signal is a signal transmitted on a PRACH or an RRC message occupying a CCCH in a random access procedure or an RRC message occupying a DCCH is dependent on a first parameter set; at least a latter of a downlink reception time and an uplink transmission time is dependent on the first parameter set.

In one embodiment, a time while a first timer is running is a time other than the uplink transmission time; the first timer is only running after being configured with a first parameter set; the meaning of when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH is: when the first timer is running, the first signal is a signal transmitted on a PRACH or an RRC message occupying a CCCH in a random access procedure, and when the first timer is not running, the first signal is an RRC message occupying a DCCH.

In one embodiment, the first timer is a timer other than T311 timer.

In one embodiment, a start condition of the first timer comprises leaving the uplink transmission time.

In one embodiment, a start condition of the first timer comprises receiving the first signaling.

In one embodiment, a start condition of the first timer comprises a first cell entering an inactive state of DTX of a cell.

In one embodiment, a start condition of the first timer comprises a first cell entering an inactive state of DTX of a cell.

In one embodiment, the meaning of the first timer is only running after being configured with a first parameter set is: when the first parameter set is not configured, the first timer is not running.

In one embodiment, the meaning of the first timer is only running after being configured with a first parameter set is: when the first parameter set is not activated, the first timer is not running.

In one embodiment, the first node only monitors dynamic scheduling of a PDCCH in an active time of a DRX.

In one embodiment, the first node only monitors a PDCCH for a C-RNTI during an active time of a DRX.

In one embodiment, the first node only monitors uplink or downlink resource allocation of a PDCCH in an active time of a DRX.

In one subembodiment of the embodiment, the resource allocation is dynamic.

In one subembodiment of the embodiment, the resource allocation is not an SPS or a CG.

In one embodiment, the first node is not required to monitor dynamic scheduling of a PDCCH outside an active time of a DRX.

In one embodiment, the first node is not required to monitor a PDCCH for a C-RNTI outside an active time of a DRX.

In one embodiment, the first timer is not a timer used to prohibit an acquisition of system information, that is, it is not an onDemandSIB RequestProhibitTimer or a T350 timer.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is the UE 201.

In one embodiment, a base station of the second node in the present application is the gNB 203.

In one embodiment, a wireless link from the UE 201 to the NR node B is uplink.

In one embodiment, a wireless link from NR node B to the UE 201 is downlink.

In one embodiment, the UE 201 supports relay transmission.

In one embodiment, the UE 201 comprises a mobile phone.

In one embodiment, the UE 201 is a vehicle comprising a car.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

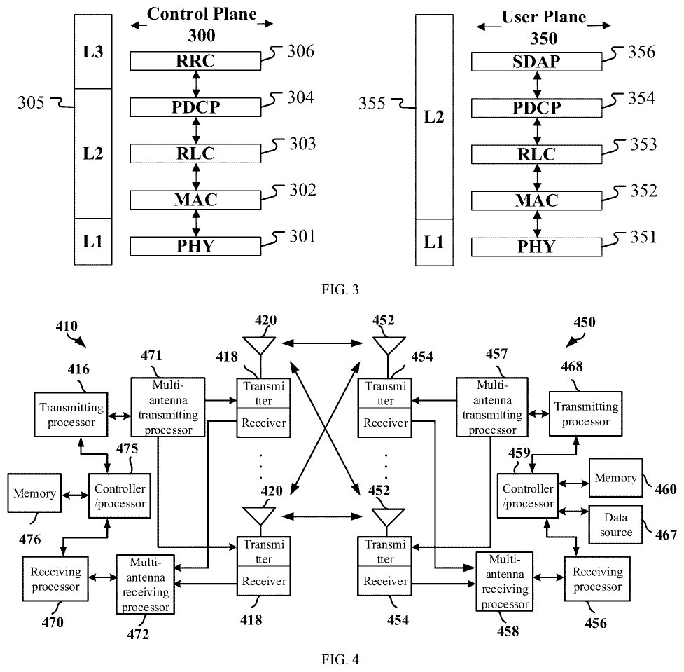

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3(L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRB comprises SRB1, SRB2, SRB3, and when it comes to sidelink communications, there is also SRB4, which is respectively used to transmit different types of control signalings. SRB, a bearer between a UE and access network, is used to transmit a control signaling, comprising an RRC signaling, between UE and access network. SRB1 has special significance for a UE. After each UE establishes an RRC connection, there will be SRB1 used to transmit RRC signaling. Most of the signalings are transmitted through SRB1. If SRB1 is interrupted or unavailable, the UE must perform RRC reconstruction. SRB2 is generally used only to transmit an NAS signaling or signaling related to security aspects. UE cannot configure SRB3. Except for emergency services, a UE must establish an RRC connection with the network for subsequent communications. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signal in the present application is generated by the PHY 301 or the MAC 302 or the RRC 306.

In one embodiment, the first system information block in the present application is generated by the RRC 306.

In one embodiment, the SIB1 in the present application is generated by the RRC 306.

In one embodiment, the first signaling in the present application is generated by the PHY 301.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: transmits a first signal, the first signal indicates a request for a first system information block; receives a first system information block transmitted by broadcast; herein, the first node is in RRC_CONNECTED state; whether the first signal is a signal transmitted on a PRACH or an RRC message occupying a CCCH in a random access procedure or an RRC message occupying a DCCH is dependent on a first parameter set; at least a latter of a downlink reception time and an uplink transmission time is dependent on the first parameter set; the meaning of whether the first signal is a signal transmitted on a PRACH or an RRC message occupying a CCCH in a random access procedure or an RRC message occupying a DCCH is dependent on a first parameter set comprises: when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH.

In one embodiment, the first communication device 450 comprises at least one processor and at least one memory. a memory that stores a computer readable instruction program. The computer readable instruction program generates an action when executed by at least one processor. The action includes: transmitting a first signal, the first signal indicating a request for a first system information block; receiving a first system information block transmitted by broadcast; herein, the first node is in RRC_CONNECTED state; whether the first signal is a signal transmitted on a PRACH or an RRC message occupying a CCCH in a random access procedure or an RRC message occupying a DCCH is dependent on a first parameter set; at least a latter of a downlink reception time and an uplink transmission time is dependent on the first parameter set; the meaning of whether the first signal is a signal transmitted on a PRACH or an RRC message occupying a CCCH in a random access procedure or an RRC message occupying a DCCH is dependent on a first parameter set comprises: when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the second communication device 450 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the SIB1 in the present application.

In one embodiment, the transmitter 454 (comprising antenna 452), the transmitting processor 468 and the controller/processor 459 are used to transmit the first signal in the present application.

### Embodiment 5

Embodiment 5 illustrates a flowchart of radio signal transmission according to one embodiment in the present application, as shown in FIG. 5. In FIG. 5, U01 corresponds to a first node in the present application. It is particularly underlined that the order illustrated in the embodiment does not put constraints over sequences of signal transmissions and implementations and steps in F51 are optional.

The first node U01 receives a first parameter set in step S5101; receives a first signaling in step S5102; receives SIB1 in step S5103; transmits a first signal in step S5104; receives a first system information block in step S5105.

The second node U02 transmits a first parameter set in step S5201; transmits a first signaling in step S5202; transmits SIB1 in step S5203; receives a first signal in step S5204; transmits a first system information block in step S5205.

In embodiment 5, the first signal indicates a request for a first system information block; herein, the first node is in RRC_CONNECTED state; whether the first signal is a signal transmitted on a PRACH or an RRC message occupying a CCCH in a random access procedure or an RRC message occupying a DCCH is dependent on a first parameter set; at least a latter of a downlink reception time and an uplink transmission time is dependent on the first parameter set; the meaning of whether the first signal is a signal transmitted on a PRACH or an RRC message occupying a CCCH in a random access procedure or an RRC message occupying a DCCH is dependent on a first parameter set comprises: when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH.

In one embodiment, in step S5205, the first system information block is transmitted in a broadcast manner.

In one embodiment, the first node U01 is not configured with the first parameter set, i.e. step S5101 does not exist, nor does step S5102, when a received SIB1 indicates that a first system information block is notBroadcasting, the first node U01 does not store a valid first system information block, the first node U01 needs to request a first system information block, meanwhile, the first signal is an RRC message occupying a DCCH, such as a DedicatedSIBRequest message, after receiving the first signal, the second node U02 transmits a first system information block in a broadcast manner, and the first node U01 receives a first system information block.

In one embodiment, the advantage of using an RRC message request system information block of a DCCH is that it is more secure.

In one embodiment, the first node U01 is configured with the first parameter set, that is, step S5101 exists, when the first node U01 does not store a valid first system information block, the first node U01 needs to request a first system information block, outside the uplink transmission time, the first signal is a signal transmitted on a PRACH or an RRC message occupying a CCCH during random access, and after receiving a first signal, the second node U02 transmits a first system information block in a broadcast manner, and the first node U01 receives a first system information block.

In one subembodiment of the embodiment, when the first node U01 only needs to request a first system information block, the first node U01 first requests a first system information block through a signal transmitted on a PRACH, because using a signal transmitted on a PRACH is more energy saving.

In one subembodiment of the embodiment, when the first node U01 needs to request multiple system information blocks, the first node U01 first requests a first system information block through an RRC message occupying a CCCH during the random access procedure, because an RRC message occupying a CCCH during the random access procedure can request multiple system information blocks at once.

In one subembodiment of the embodiment, the meaning of being configured with a first parameter set comprises that the first parameter set is activated.

In one embodiment, the advantages of using an RRC message occupying a CCCH during random access procedure to request a system information block are that it is more flexible, timely, and not limited by system resource configuration.

In one embodiment, the first node U01 is configured with the first parameter set, that is, the step S5101 exists, when the first node U01 does not store a valid first system information block, the first node U01 needs to request a first system information block, within the uplink transmission time, the first signal is an RRC message occupying a DCCH, and after receiving a first signal, the second node U02 transmits a first system information block in a broadcast manner, and the first node U01 receives a first system information block.

In one embodiment, the advantage that an RRC message using a DCCH to request a system information block is that it is more secure.

In one embodiment, the second node U02 is an SpCell of the first node U01.

In one embodiment, the second node U02 is an MCG of the first node U01.

In one embodiment, the second node U02 is the first cell.

In one embodiment, the second node U02 is a PCell or a base station corresponding to PCell of the first node U01.

In one embodiment, a communication interface between the first node U01 and the second node U02 is a Uu interface.

In one embodiment, the present application does not limit a transmitter of the first system information block to be the same as a receiver of the first signal.

In one embodiment, the present application does not limit a transmitter of a first signaling to be the same as a receiver of the first signal.

In one embodiment, the present application does not limit a transmitter of a first signaling to be the same as a transmitter of the first system information block.

In one embodiment, the step S5102 depends on step S5101.

In one embodiment, the step S5102 is after the step S5101.

In one embodiment, the step S5103 is before the step S5102, or the step S5103 is after the step S5102.

In one embodiment, the step S5104 is after the step S5103.

In one embodiment, the step S5104 is after the step S5102.

In one embodiment, the step S5104 is after the step S5101.

In one embodiment, the step S5105 is after the step S5104.

In one embodiment, the step S5105 is after the step S5204.

In one embodiment, an air interface between the first node U01 and the second node U02 is a Uu interface.

In one embodiment, the second node U02 belongs to NR network.

In one embodiment, an RRC connection is established between networks to which the first node U01 and the second node U02 belong.

In one embodiment, the first parameter set is specific to the first node U01 or to users of an entire cell.

In one embodiment, the first parameter set is either valid or activated upon being received.

In one embodiment, the first parameter set is not activated after being received, which is equivalent to not receiving the first parameter set, in the present application, the meaning of receiving the first parameter set means receiving the first parameter set and the effectiveness of the first parameter set does not need to be activated or receiving an indication to activate the first parameter set.

In one embodiment, in the present application, the meaning of not receiving the first parameter set is: not receiving the first parameter set or although receiving the first parameter set, but the first parameter set is not activated.

In one embodiment, a first signaling signal is received, the first signaling is DCI, the first signaling indicates activating the first parameter set, a first RNTI scrambles the first signaling, and the first RNTI is an RNTI other than an SI-RNTI, a G-RNTI, a PS-RNTI, and a C-RNTI;
herein, the first signaling is transmitted on a PDCCH.

In one embodiment, the first signaling is a physical-layer signaling.

In one embodiment, the meaning of the first signaling indicates activating the first parameter set comprises: receiving the first signaling, the first parameter set then being activated.

In one subembodiment of the embodiment, the first signaling is associated with the first parameter set.

In one subembodiment of the embodiment, an RNTI scrambling the first signaling is associated with the first parameter set.

In one embodiment, the meaning of the first signaling indicates activating the first parameter set comprises: the first signaling indicating a first parameter set.

In one embodiment, the meaning of the first signaling indicates activating the first parameter set comprises: the first signaling indicating a configuration identity or configuration index of a first parameter set.

In one embodiment, the meaning of the first signaling indicates activating the first parameter set comprises: the first signaling indicating a first cell, and the first parameter set being specific to the first cell.

In one embodiment, the meaning of the first signaling indicates activating the first parameter set comprises: the first parameter set being configured by an RRC message, and the first parameter set not being activated before the first signaling.

In one embodiment, the first RNTI is not a C-RNTI.

In one embodiment, the first RNTI is not a G-RNTI.

In one embodiment, the first RNTI is not an SI-RNTI.

In one embodiment, the first RNTI is an RNTI of broadcast or multicast type.

In one embodiment, the first RNTI is an N-RNTI.

In one embodiment, the first RNTI is an NS-RNTI.

In one embodiment, the first RNTI is an NES-RNTI.

In one embodiment, an RRC message configuring the first parameter set indicates the first RNTI.

In one embodiment, the first RNTI is a P-RNTI.

In one subembodiment of the embodiment, advantages of the first RNTI being a P-RNTI comprise simplifying the design and reusing the existing paging RNTI.

In one embodiment, the first RNTI is not a P-RNTI.

In one subembodiment of the embodiment, advantages of the first RNTI being not P-RNTI is that it is independently designed without affecting paging, reducing the complexity, and can be different from a paging cycle, making it more flexible.

In one embodiment, the SIB1 indicates that a first system information block is notBroadcasting;
herein, the first node does not store a valid first system information block; the first node's not storing a valid first system information block triggers transmitting a first signal.

In one embodiment, SIB1 defines the scheduling of other system information blocks and contains necessary information for initial access; SIB1 is periodically transmitted on a DL-SCH (downlink shared channel) or transmitted to a node in RRC_CONNECTED state through dedicated means.

In one embodiment, the meaning of the SIB1 indicates that a first system information block is notBroadcasting comprises: the SIB1 indicates the first system information block notBroadcasting.

In one embodiment, the meaning of the SIB1 indicates that a first system information block is notBroadcasting comprises: a broadcast state of the SIB1 indicating a first system information block is notBroadcasting.

In one embodiment, the meaning of the SIB1 indicates that a first system information block is notBroadcasting comprises: si-BroadcastStatus of the SIB1 indicates the first system information block notBroadcasting.

In one embodiment, the meaning of the SIB1 indicates that a first system information block is notBroadcasting comprises: posSI-BroadcastStatus of the SIB1 indicates the first system information block notBroadcasting.

In one embodiment, the meaning of the SIB1 indicates that a first system information block is notBroadcasting comprises: a first system information block needs to be requested to be received.

In one embodiment, the meaning of the first node does not store valid first system information block comprises: the first node does not store a first system information block.

In one embodiment, the meaning of the first node does not store valid first system information block comprises: a first system information block stored by the first node expires.

In one embodiment, the meaning of the first node does not store valid first system information block comprises: the first node receives an indication that a first system information block has been updated, but has not yet received an updated first system information block.

In one subembodiment of the embodiment, the first node receives the indication that a first system information block has been updated through SIB1 or a paging message.

### Embodiment 6

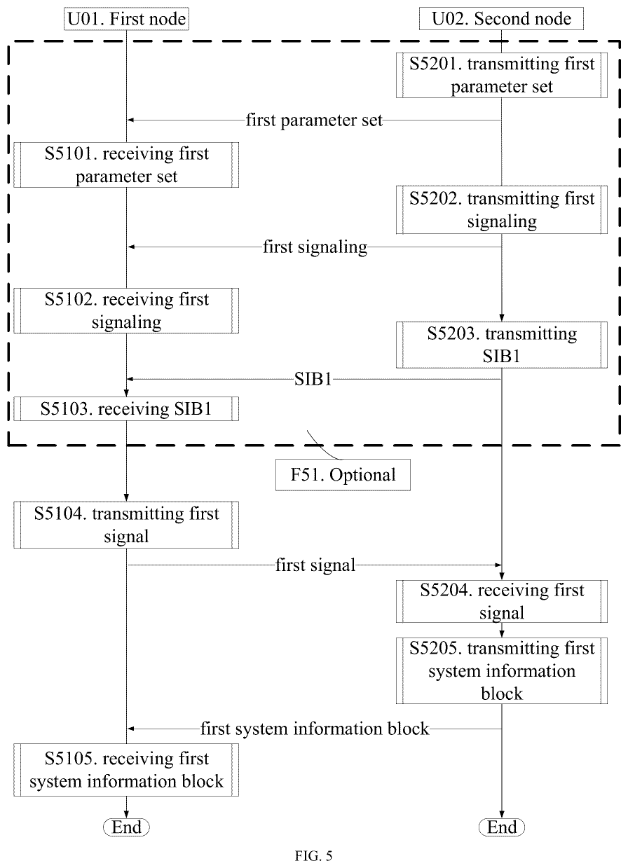

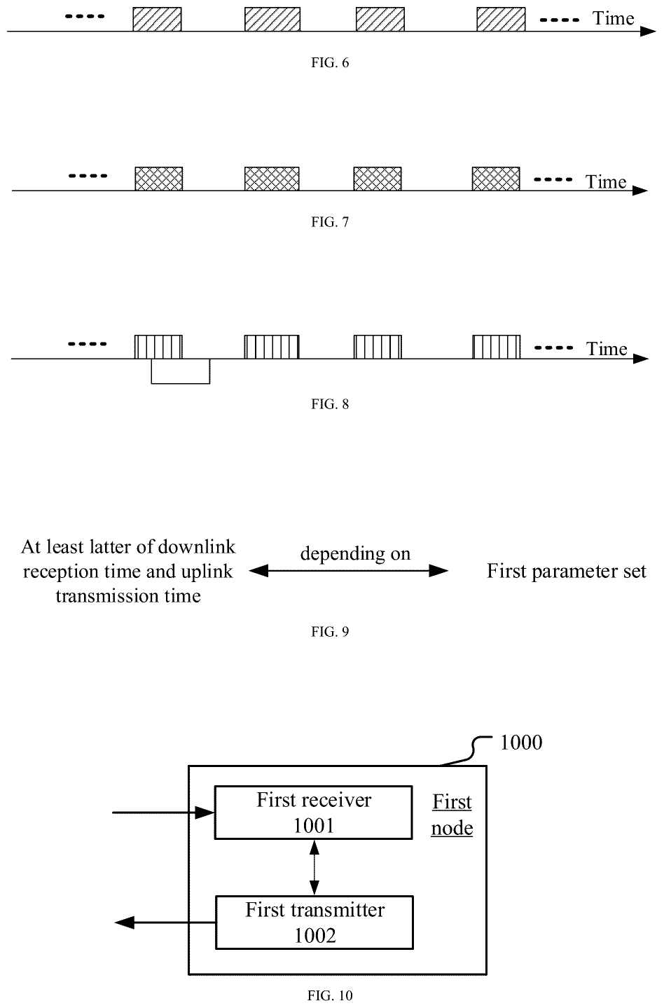

Embodiment 6 illustrates a schematic diagram of a downlink reception time according to one embodiment of the present application, as shown in FIG. 6.

FIG. 6 illustrates that the downlink reception time depends on the first parameter set, each shaded rectangle in FIG. 6 represents a downlink reception time, and the outer part of each shaded rectangle represents non-downlink reception time or a time outside a downlink reception time; the method proposed in the present application does not limit a start time and an end time and a time length of a downlink reception time, that is, does not limit a number and length of shaded blocks in FIG. 6.

In one embodiment, the downlink reception time has a clear termination time.

In one embodiment, the first node is required to monitor a physical downlink control channel (PDCCH) within the downlink reception time.

In one subembodiment of the embodiment, the monitoring a PDCCH is for a PDCCH addressed to C-RNTI.

In one subembodiment of the embodiment, the monitoring a PDCCH is a dynamic scheduling of monitoring a PDCCH.

In one embodiment, the first node is required to monitor a physical downlink control channel (PDCCH) for a C-RNTI within the downlink reception time.

In one embodiment, the first node does not expect to receive a HARQ feedback in a time outside the downlink reception time.

In one embodiment, the first node does not expect to be scheduled in a time outside the downlink reception time.

In one embodiment, the first node is not required to monitor a PDCCH in a time outside the downlink reception time.

In one embodiment, the first node is not required to monitor a PDCCH for a C-RNTI in a time outside the downlink reception time.

In one embodiment, the first node does not monitor an SPS occasion in a time outside the downlink reception time.

In one embodiment, the downlink reception time is applicable to a DCI scrambled by a C-RNTI.

In one embodiment, the downlink reception time is applicable to a CSI-RS.

In one subembodiment of the above embodiment, the first node only receives a CSI-RS within the downlink reception time.

In one embodiment, the downlink reception time is applicable to an SPS (semi-persistent scheduling).

In one embodiment, a downlink reception time is determined by the first parameter set.

In one embodiment, a downlink reception time for a first cell is determined by the first parameter set.

In one embodiment, a downlink reception time for an MCG and/or SCG is determined by the first parameter set.

In one embodiment, a downlink reception time of a cell belonging to a TAG (timing advance group) is determined by the first parameter set.

In one embodiment, a downlink reception time determined by the first parameter set comprises a start of the downlink reception time.

In one embodiment, a downlink reception time determined by the first parameter set is always continuous after the start.

In one embodiment, a downlink reception time determined by the first parameter set comprises a start and an end of the downlink reception time.

In one embodiment, a downlink reception time determined by the first parameter set comprises multiple discontinuous time periods.

In one embodiment, a downlink reception time determined by the first parameter set comprises a finite number of discontinuous time periods.

In one embodiment, a downlink reception time determined by the first parameter set comprises an infinite number of discontinuous time periods.

In one embodiment, a downlink reception time determined by the first parameter set is multiple time periods.

In one subembodiment of the embodiment, a length of each time period in the multiple time periods is equal.

In one subembodiment of the embodiment, the multiple time periods comprise at least two time periods of varying lengths.

In one subembodiment of the embodiment, a time interval between any two adjacent time periods in the multiple time periods is equal.

In one subembodiment of the embodiment, the multiple time periods comprise that a time interval between at least one pair of adjacent time periods is not equal to a time interval between another pair of adjacent time periods.

In one embodiment, the first parameter set explicitly indicates parameters of a downlink reception time.

In one embodiment, the first parameter set comprises a transmission time of a system information block.

In one embodiment, the first parameter set comprises a transmission time of an SSB.

In one embodiment, the first parameter set comprises a first factor, and the first factor together with a first time length are used together to determine the downlink reception time.

In one subembodiment of the embodiment, the first factor is a scaling factor.

In one subembodiment of the embodiment, the first time length is a period of an SIB.

In one subembodiment of the embodiment, the first time length is a period of an SIB1.

In one subembodiment of the embodiment, the first time length is a period of an SSB.

In one subembodiment of the embodiment, the first time length is a paging period.

In one subembodiment of the embodiment, the first time length is a period of DRX.

In one subembodiment of the embodiment, the first factor is not equal to 1.

In one subembodiment of the embodiment, the first factor is greater than 1.

In one subembodiment of the embodiment, a product of the first factor and the first time length is used to determine a time interval between any two adjacent time periods in the multiple time periods.

In one embodiment, the first parameter set indicates the downlink reception time through a time other than the downlink reception time.

In one embodiment, the downlink reception time is specific to the first cell.

In one embodiment, the downlink reception time is a time when the first cell is in active state.

In one embodiment, the downlink reception time is a time when the first cell is in first state.

In one embodiment, the downlink reception time is a time when the first cell is in a non NES (network energy saving) state.

In one embodiment, the downlink reception time is an active time when the first cell is in DTX.

In one embodiment, the first parameter set comprises time parameters of at least one reference signal resource.

In one embodiment, the first parameter set comprises a period of the downlink reception time.

In one embodiment, the first parameter set comprises a period of a time period of the downlink reception time.

In one embodiment, the first parameter set comprises time window information of a system information block.

In one embodiment, a period of a time period comprised in a downlink reception time is equal to a period of a system information block.

### Embodiment 7

Embodiment 7 illustrates a schematic diagram of an uplink transmission time according to one embodiment of the present application, as shown in FIG. 7.

FIG. 7 shows that the uplink transmission time depends on the first parameter set, the shaded rectangle in FIG. 7 represents an uplink transmission time, and the outer part of each shaded rectangle represents non-uplink transmission time or a time outside an uplink transmission time; the method proposed in the present application does not limit a start and end times as well as a length of the uplink transmission time, as well as does not limit a number and length of the shaded rectangles in FIG. 7.

In one embodiment, the uplink transmission time has a clear termination time.

In one embodiment, the first node performs an uplink transmission within the uplink transmission time.

In one embodiment, the first node is not required to perform a transmission in time outside the uplink transmission time.

In one embodiment, the first node does not expect to be indicated to perform an uplink transmission in time outside the uplink transmission time.

In one embodiment, the uplink transmission time is applicable to data.

In one embodiment, the uplink transmission time is applicable to signaling.

In one embodiment, the uplink transmission time is applicable to UCI (uplink control information).

In one embodiment, the uplink transmission time is applicable to a MAC CE.

In one embodiment, the uplink transmission time is applicable to a reference signal or reference signal resources.

In one embodiment, the uplink transmission time is applicable to an SRS (sound reference signal).

In one embodiment, the uplink transmission time is applicable to a CG (configured grant).

In one embodiment, an uplink transmission time determined by the first parameter set comprises a start of an uplink transmission time.

In one embodiment, an uplink transmission time determined by the first parameter set is always continuous after the start.

In one embodiment, an uplink transmission time determined by the first parameter set comprises a start and an end of an uplink transmission time.

In one embodiment, an uplink transmission time determined by the first parameter set comprises multiple discontinuous time periods.

In one embodiment, an uplink transmission time determined by the first parameter set comprises a finite number of discontinuous time periods.

In one embodiment, an uplink transmission time determined by the first parameter set comprises an infinite number of discontinuous time periods.

In one embodiment, an uplink transmission time determined by the first parameter set is multiple time periods.

In one subembodiment of the embodiment, a length of each time period in the multiple time periods of the uplink transmission time is equal.

In one subembodiment of the embodiment, the multiple time periods of the uplink transmission time comprise at least two time periods of varying lengths.

In one subembodiment of the embodiment, a time interval between any two adjacent time periods in the multiple time periods of the uplink transmission time is equal.

In one subembodiment of the embodiment, the multiple time periods of the uplink transmission time comprise that a time interval between at least one pair of adjacent time periods is not equal to a time interval between another pair of adjacent time periods.

In one embodiment, the first parameter set explicitly indicates parameters of an uplink transmission time.

In one embodiment, the first parameter set comprises a transmission time of a system information block.

In one embodiment, the first parameter set comprises a transmission time of an SSB.

In one embodiment, the first parameter set comprises a first factor, and the first factor together with the first time length are used to determine the uplink transmission time.

In one subembodiment of the embodiment, the first factor is a scaling factor.

In one subembodiment of the embodiment, the first time length is a period of an SIB.

In one subembodiment of the embodiment, the first time length is a period of an SIB1.

In one subembodiment of the embodiment, the first time length is a period of an SSB.

In one subembodiment of the embodiment, the first time length is a paging period.

In one subembodiment of the embodiment, the first time length is a period of DRX.

In one subembodiment of the embodiment, the first factor is not equal to 1.

In one subembodiment of the embodiment, the first factor is greater than 1.

In one subembodiment of the embodiment, a product of the first factor and the first time length is used to determine a time interval between any two adjacent durations in multiple durations of an uplink transmission time.

In one embodiment, the first parameter set indicates the uplink transmission time through a time other than the uplink transmission time.

In one embodiment, an uplink transmission time of an MCG and/or SCG is determined by the first parameter set.

In one embodiment, an uplink transmission time of a cell belonging to a TAG (timing advance group) is determined by the first parameter set.

In one embodiment, the uplink transmission time is specific to the first cell.

In one embodiment, the uplink transmission time is a time when the first cell is in active state.

In one embodiment, the uplink transmission time is a time when the first cell is in the first state.

In one embodiment, the uplink transmission time is a time when the first cell is in a non NES (network energy saving) state.

In one embodiment, the uplink transmission time is an active time when the first cell is in DRX.

In one embodiment, the first parameter set comprises time parameters of at least one reference signal resource.

In one embodiment, the first parameter set comprises a period of the uplink transmission time.

In one embodiment, the first parameter set comprises a period of a time duration of the uplink transmission time.

In one embodiment, the first parameter set comprises time window information of a system information block.

In one embodiment, a period of a time period comprised in an uplink transmission time is equal to a period of a system information block.

In one embodiment, the uplink transmission time is overlapping or coincided with a downlink reception time determined by the first parameter set.

In one embodiment, the uplink transmission time does not coincide with a downlink reception time determined by the first parameter set.

In one embodiment, the uplink transmission time has a fixed offset in time from a downlink reception time determined by the first parameter set.

### Embodiment 8

Embodiment 8 illustrates a schematic diagram of DRX according to one embodiment of the present application.

The shaded rectangle in FIG. 8 represents any of the uplink transmission time or downlink reception time, and correspondingly, the outer part of each shaded rectangle represents time outside the uplink transmission time or time outside downlink reception time; each shaded rectangle in FIG. 8 represents a continuous time period; the method proposed in the present application does not limit a start time and an end time as well as a length of the uplink transmission time or downlink reception time, as well as does not limit a number and length of the shaded rectangles in FIG. 8; the unfilled rectangle in FIG. 8 represents any continuous active time of DRX of a first node; the method proposed in the present application does not limit a start time and an end time of an active time of a DRX of the first node, nor does it limit how many continuous time periods an active time of a DRX of the first node comprises.

In one embodiment, an active time of a DRX of the first node is also an active time of a DRX of a MAC or an active time of a MAC of the first node.

In one embodiment, an active time of a DRX of the first node is also an active time of a DRX group of the first node.

In one embodiment, a DRX of the first node is configured by the network.

In one embodiment, a start of the DRX cycle of the first node corresponds to a start of an onduration timer of DRX.

In one embodiment, a continuous active time of the DRX of the first node comprises a running of an onduration timer of DRX.

In one embodiment, an onduration timer of DRX of the first node is configured by the network.

In one embodiment, an active time of the DRX of the first node is unrelated to the uplink transmission time.

In one embodiment, an active time of the DRX of the first node is unrelated to the downlink reception time.

In one embodiment, advantages of the DRX active time of the first node being independent of the uplink transmission time or downlink reception time is that a DRX of the first node can be independently configured, which is more flexible.

In one embodiment, a start of a continuous active time of the DRX of the first node is the same as a start of a continuous time period of the downlink reception time.

In one embodiment, an end of a continuous active time of the DRX of the first node is not later than an end of a continuous time period of the downlink reception time.

In one embodiment, an end of a continuous time period of the downlink reception time is used to determine an end of a continuous active time period of the DRX of the first node.

In one embodiment, the network can configure an active time of a DRX of the first node based on the downlink transmission time, which is beneficial for simplifying operations and reducing the complexity.

In one embodiment, a DRX period of the first node is the same as a period of multiple time periods comprised in the downlink reception time.

In one embodiment, a DRX period of the first node is different from a period of multiple time periods comprised in the downlink reception time.

In one embodiment, a DRX period of the first node is N times a period of multiple time periods comprised in the downlink reception time, where N is a positive integer.

In one embodiment, a start of a continuous active time of a DRX cycle of the first node has a fixed offset relative to a start of a time period comprised in the downlink reception time.

In one embodiment, a minimum value of an offset of a start of any continuous active time in a DRX cycle of the first node relative to a start of all continuous time periods comprised in the downlink reception time is equal.

### Embodiment 9

Embodiment 9 illustrates a schematic diagram of at least a latter of a downlink reception time and an uplink transmission time depending on a first parameter set according to one embodiment of the present application, as shown in FIG. 9.

In one embodiment, the first parameter set comprises a configuration index or configuration identity, and a configuration of the configuration index or configuration identity used for identification is used to configure at least a latter of the downlink reception time and the uplink transmission time.

In one embodiment, the first parameter set determines the downlink reception time, and the downlink reception time determines the uplink transmission time.

In one embodiment, the first parameter set determines the uplink transmission time, and the uplink transmission time is used to determine the downlink reception time.

In one embodiment, the first parameter set indicates a start of at least one of the downlink reception time and the uplink transmission time.

In one subembodiment of the embodiment, the at least one of the downlink reception time or the uplink transmission time determines the other of the downlink reception time and the uplink transmission time.

In one embodiment, the first parameter set indicates a duration of at least a latter of the downlink reception time and the uplink transmission time.

In one embodiment, the first parameter set indicates an end of at least a latter of the downlink reception time and the uplink transmission time.

In one embodiment, the first parameter set indicates a time period comprised in at least a latter of the downlink reception time and the uplink transmission time.

In one embodiment, the first parameter set indicates a period of at least a latter of the downlink reception time and the uplink transmission time.

In one embodiment, the downlink reception time and the uplink transmission time have a fixed time relation.

In one embodiment, the first parameter set comprises a first offset, and the first offset is used to indicate at least one of the downlink reception time and the uplink transmission time.

In one subembodiment of the embodiment, the first offset indicates a time offset of at least one of the downlink reception time and uplink transmission time relative to system information.

In one subembodiment of the embodiment, the first offset indicates a time offset of at least one of the downlink reception time and uplink transmission time relative to a reference signal or reference signal resources.

In one embodiment, the first parameter set comprises a system fame number, and the system frame number is used to determine at least one of the downlink reception time and the uplink transmission time.

In one embodiment, the first parameter set indicates at least one of the downlink reception time or the uplink transmission time by indicating a relation of at least one of the downlink reception time or the uplink transmission time and system information.

In one embodiment, the first parameter set indicates the downlink reception time through a time other than the downlink reception time.

In one embodiment, the first parameter set indicates the uplink transmission time through a time other than the uplink transmission time.

In one embodiment, the first parameter set indicates immediate leaving a downlink reception time.

In one embodiment, the first parameter set indicates immediate leaving an uplink transmission time.

In one embodiment, the first parameter set indicates a moment when leaving a downlink reception time.

In one embodiment, the first parameter set indicates a moment when leaving an uplink transmission time.

In one embodiment, the first parameter set indicates a duration when leaving a downlink reception time.

In one embodiment, the first parameter set indicates a duration when leaving an uplink transmission time.

In one embodiment, the first parameter set comprises DTX parameters of the first cell to indicate the downlink reception time.

In one embodiment, the first parameter set comprises DRX parameters of the first cell to indicate the uplink transmission time.

In one embodiment, the first cell is not deactivated.

In one embodiment, the first node can measure the first cell at a time outside a downlink reception time.

In one embodiment, the first node can measure reference signal resources for the first cell at a time outside a downlink reception time.

In one embodiment, the first parameter set comprises a template for the downlink reception time.

In one embodiment, the first parameter set comprises a template for the uplink transmission time.

In one embodiment, after receiving the first parameter set, there at least exists one period of time not belonging to a downlink reception time.

In one embodiment, after receiving the first parameter set, there at least exists one period of time not belonging to an uplink transmission time.

In one embodiment, the first parameter set is for a cell.

In one embodiment, within a downlink reception time determined by the first parameter set, the first node can be in an active time of a DRX or in an inactive time of DRX.

In one embodiment, within an uplink transmission time determined by the first parameter set, the first node can be in an active time of a DRX or in an inactive time of DRX.

In one embodiment, the downlink reception time comprises multiple discontinuous time periods, and the first parameter set indicates the multiple discontinuous time periods.

In one embodiment, the uplink transmission time comprises multiple discontinuous time periods, and the first parameter set indicates the multiple discontinuous time periods.

In one embodiment, the first signaling explicitly comprises at least one parameter in the first parameter set.

In one embodiment, the first signaling indicates applying or activating the first parameter set.

In one embodiment, the first signaling indicates an identity of the first parameter set.

In one embodiment, the first signaling indicates that the first parameter set is applied to the first cell.

In one embodiment, after applying the first parameter set, the first cell does not transmit any signal in at least part of time.

In one embodiment, after applying the first parameter set, the first cell does not receive any signal in at least part of time.

In one embodiment, the first parameter set indicates an active time of DTX of a first cell; the active time of the DTX is or is used to determine the downlink transmission time.

In one embodiment, the first parameter set indicates an active time of a DRX of a first cell; the active time of the DRX is or is used to determine the uplink transmission time.

In one embodiment, the first parameter set indicates an active time of downlink; the active time of the downlink is or is used to determine the downlink transmission time.

In one subembodiment of the above embodiment, the active time of the downlink is for the first cell.

In one embodiment, the first parameter set indicates an active time of uplink; the active time of the uplink is or is used to determine the uplink transmission time.

In one subembodiment of the above embodiment, the active time of the uplink is for the first cell.

In one embodiment, the first parameter set indicates a downlink transmission time for a first cell; the downlink transmission time for the first cell is or is used to determine the downlink reception time.

In one subembodiment of the above embodiment, the downlink reception time is specific to the first node.

In one embodiment, the first parameter set indicates an uplink reception time for a first cell; the uplink reception time for the first cell is or is used to determine the uplink transmission time.

In one subembodiment of the above embodiment, the uplink transmission time is specific to the first node.

In one embodiment, the first parameter set indicates whether the uplink transmission time and downlink reception time are the same.

In one embodiment, the first signaling indicates whether the uplink transmission time and downlink reception time are the same.

### Embodiment 10

Embodiment 10 illustrates a structure block diagram of a processor in a first node according to one embodiment of the present application, as shown in FIG. 10. In FIG. 10, a processor 1000 in a first node comprises a first receiver 1001 and a first transmitter 1002. In Embodiment 10,
the first transmitter 1002 transmits a first signal, and the first signal indicates a request for a first system information block;
the first receiver receives a first system information block transmitted by broadcast;
herein, the first node is in RRC_CONNECTED state; whether the first signal is a signal transmitted on a PRACH or an RRC message occupying a CCCH in a random access procedure or an RRC message occupying a DCCH is dependent on a first parameter set; at least a latter of a downlink reception time and an uplink transmission time is dependent on the first parameter set; the meaning of whether the first signal is a signal transmitted on a PRACH or an RRC message occupying a CCCH in a random access procedure or an RRC message occupying a DCCH is dependent on a first parameter set comprises: when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH.

In one embodiment, T311 timer is not running.

In one embodiment, the first node only receives a paging message within the downlink reception time.

In one embodiment, the first receiver 1001 receives SIB1, and the SIB1 indicates that a first system information block is notBroadcasting;
herein, the first node does not store a valid first system information block; the first node's not storing a valid first system information block triggers transmitting a first signal.

In one embodiment, the first receiver 1001 receives a first signaling, the first signaling is DCI, the first signaling indicates activating the first parameter set, a first RNTI scrambles the first signaling, and the first RNTI is an RNTI other than an SI-RNTI, a G-RNTI, a PS-RNTI, and a C-RNTI;
herein, the first signaling is transmitted on a PDCCH.

In one embodiment, the first node only monitors an SPS occasion within the downlink reception time; the first node only performs a transmission on a CG occasion within the uplink transmission time; the first node only transmits an SR within the uplink transmission time.

In one embodiment, whether the first node monitors an SPS occasion is unrelated to whether the first node is in an active time of a DRX.

In one embodiment, whether the first node performs a transmission on a CG occasion is unrelated to whether the first node is in an active time of a DRX.

In one embodiment, a time while a first timer is running is a time other than the uplink transmission time; the first timer is only running after being configured with a first parameter set; the meaning of when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH is: when the first timer is running, the first signal is a signal transmitted on a PRACH or an RRC message occupying a CCCH in a random access procedure, and when the first timer is not running, the first signal is an RRC message occupying a DCCH.

In one embodiment, the first node is a UE.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things terminal or an Industrial Internet of Things terminal.

In one embodiment, the first node is a device that supports transmission with low-latency and high-reliability.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transmitter, transmitting a first signal, the first signal indicating a request for a first system information block; and
a first receiver, receiving a first system information block transmitted by broadcast;
wherein the first node is in RRC (radio resource control) connected state; whether the first signal is a signal transmitted on a PRACH (physical random access channel) or an RRC message occupying a CCCH (Common control channel) in a random access procedure or an RRC message occupying a DCCH (Dedicated Control CHannel) is dependent on a first parameter set; at least a latter of a downlink reception time and an uplink transmission time is dependent on the first parameter set; the meaning of whether the first signal is a signal transmitted on a PRACH or an RRC message occupying a CCCH in a random access procedure or an RRC message occupying a DCCH is dependent on a first parameter set comprises: when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH.

2. The first node according to claim 1, wherein T311 timer is not running.

3. The first node according to claim 1, wherein the first node only receives a paging message within the downlink reception time.

4. The first node according to claim 2, wherein the first node only receives a paging message within the downlink reception time.

5. The first node according to claim 1, comprising:
a first receiver, receiving SIB1 (System information Block 1), the SIB1 indicating that a first system information block is notBroadcasting;
wherein the first node does not store a valid first system information block; the first node's not storing a valid first system information block triggers transmitting a first signal.

6. The first node according to claim 2, comprising:
the first receiver, receiving SIB1, the SIB1 indicating that a first system information block is notBroadcasting;
wherein the first node does not store a valid first system information block; the first node's not storing a valid first system information block triggers transmitting a first signal.

7. The first node according to claim 1, comprising:
the first receiver, receiving a first signaling, the first signaling being DCI (Downlink Control Information), the first signaling indicating an activation of the first parameter set, a first RNTI (Radio Network Temporary Identification) scrambling the first signaling, and the first RNTI being an RNTI other than an SI-RNTI (system information-RNTI), a G-RNTI (Group-RNTI), a PS-RNTI (Power Saving-RNTI), and a C-RNTI (Cell-RNTI);
wherein the first signaling is transmitted on a Physical downlink control channel (PDCCH).

8. The first node according to claim 2, comprising:
the first receiver, receiving a first signaling, the first signaling being DCI, the first signaling indicating activating the first parameter set, a first RNTI scrambling the first signaling, and the first RNTI being an RNTI other than an SI-RNTI, a G-RNTI, a PS-RNTI, and a C-RNTI;
wherein the first signaling is transmitted on a PDCCH.

9. The first node according to claim 5, comprising:
the first receiver, receiving a first signaling, the first signaling being DCI, the first signaling indicating activating the first parameter set, a first RNTI scrambling the first signaling, and the first RNTI being an RNTI other than an SI-RNTI, a G-RNTI, a PS-RNTI, and a C-RNTI;
wherein the first signaling is transmitted on a PDCCH.

10. The first node according to claim 8, wherein the first RNTI is a network energy saving-RNTI (NES-RNTI).

11. The first node according to claim 9, wherein the first RNTI is an NES-RNTI.

12. The first node according to claim 1, wherein
the first node only monitors an SPS (Semi-persistent Scheduling) occasion within the downlink reception time; the first node only performs a transmission on a CG (Configured Grant) occasion within the uplink transmission time; the first node only transmits an SR within the uplink transmission time.

13. The first node according to claim 1, wherein
whether the first node monitors an SPS occasion is unrelated to whether the first node is in an active time of a Discontinuous Reception (DRX).

14. The first node according to claim 1, wherein
whether the first node performs a transmission on a CG occasion is unrelated to whether the first node is in an active time of a DRX.

15. The first node according to claim 1, wherein
a time while a first timer is running is a time other than the uplink transmission time; the first timer is only running after being configured with a first parameter set; the meaning of when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH is: when the first timer is running, the first signal is a signal transmitted on a PRACH or an RRC message occupying a CCCH in a random access procedure, and when the first timer is not running, the first signal is an RRC message occupying a DCCH.

16. A method in a first node for wireless communications, comprising:
transmitting a first signal, the first signal indicating a request for a first system information block; and
receiving a first system information block transmitted by broadcast;
wherein the first node is in RRC_CONNECTED state; whether the first signal is a signal transmitted on a PRACH or an RRC message occupying a CCCH in a random access procedure or an RRC message occupying a DCCH is dependent on a first parameter set; at least a latter of a downlink reception time and an uplink transmission time is dependent on the first parameter set; the meaning of whether the first signal is a signal transmitted on a PRACH or an RRC message occupying a CCCH in a random access procedure or an RRC message occupying a DCCH is dependent on a first parameter set comprises: when the first parameter set is received and outside the uplink transmission time, the first signal is a signal transmitted on a PRACH or an RRC message occupying a CCCH in a random access procedure, when the first parameter set is not received, the first signal is an RRC message occupying a DCCH; when the first parameter set is received and within the uplink transmission time, the first signal is an RRC message occupying a DCCH.

17. The method in a first node according to claim 16, wherein T311 timer is not running.

18. The method in a first node according to claim 16, comprising:
receiving SIB1, the SIB1 indicating that a first system information block is notBroadcasting;
wherein the first node does not store a valid first system information block; the first node's not storing a valid first system information block triggers transmitting a first signal.

19. The method in a first node according to claim 16, comprising:
receiving a first signaling, the first signaling being DCI, the first signaling indicating activating the first parameter set, a first RNTI scrambling the first signaling, and the first RNTI being an RNTI other than an SI-RNTI, a G-RNTI, a PS-RNTI, and a C-RNTI;
wherein the first signaling is transmitted on a PDCCH.

20. The method in a first node according to claim 19, wherein the first RNTI is an NES-RNTI.
